(19) United States
(12) Patent Application Publication
(10) Pub. No.: US 2020/0058158 A1
(43) Pub. Date: Feb. 20, 2020

(54) SYSTEM AND METHOD FOR OBJECT LOCATION DETECTION FROM IMAGERY

(71) Applicant: Uber Technologies, Inc., San Francisco, CA (US)

(72) Inventors: Fritz Obermeyer, San Francisco, CA (US); Jonathan Chen, San Francisco, CA (US); Vladimir Lyapunov, Erie, CO (US); Lionel Gueguen, Erie, CO (US); Noah Goodman, Menlo Park, CA (US); Benjamin James Kadlec, Boulder, CO (US); Douglas Bemis, San Francisco, CA (US)

(21) Appl. No.: 16/536,869

(22) Filed: Aug. 9, 2019

Related U.S. Application Data
(60) Provisional application No. 62/718,985, filed on Aug. 16, 2018.

(51) Int. Cl. G06T 15/20; G06T 7/70; G06T 17/05; G01C 21/32

(52) U.S. Cl. CPC G06T 15/205; G06T 7/70; G06T 2207/30252; G01C 21/32; G06T 17/05

(57) ABSTRACT

Example systems and methods improve a location detection process. A system accesses image data and image metadata, whereby the image data captures images of a plurality of objects from different views, each image having corresponding image metadata. The system then detects each object in the plurality of objects in the image data. A plurality of rays in three-dimensional space is generated, whereby each ray of the plurality of rays is generated based on the detected objects and the corresponding image metadata. The system predicts object locations using the generated rays based on a probabilistic triangulation of the rays. The networked system updates map data using the predicted object locations. The updating includes adding objects at their predicted object locations to the map data. The map data is used to generate a map.

### REFERENCE TO RELATED APPLICATIONS

This application claims the priority benefit of U.S. Provisional Patent Application No. 62/718,985 filed Aug. 16, 2018 and entitled “System and Method for Object Location Detection from Imagery,” which is incorporated herein by reference in its entirety.

### TECHNICAL FIELD

The subject matter disclosed herein generally relates to machines configured to special-purpose machines for determining object locations, and to technologies by which such special-purpose machines become improved compared to other machines that determine object locations. Specifically, the present disclosure addresses systems and methods to detect object locations from a plurality of images.

### BACKGROUND

Presently, some location detection processes use Light Detection and Ranging (LIDAR) to identify objects in the real world. However, the use of LIDAR requires expensive and complicated equipment. Additionally, the use of LIDAR may be computationally expensive.

### BRIEF DESCRIPTION OF DRAWINGS

Various ones of the appended drawings merely illustrate example embodiments of the present invention and cannot be considered as limiting its scope.

FIG. 1 is a diagram illustrating a network environment suitable for performing object location detection using images, according to some example embodiments.

FIG. 2 is a block diagram illustrating components of a networked system, according to some example embodiments.

FIG. 3 is a flowchart illustrating operations of a method for generating a map based on object locations, according to some example embodiments.

FIG. 4 is a flowchart illustrating operations of a method for determining map locations that includes machine training of parameters, according to some example embodiments.

FIG. 5 is a flowchart illustrating operations of a method of the machine training, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions for improving a location detection process to identify locations of objects, such as signs, in a real-world environment based on images. In order to avoid the use of LIDAR systems, example embodiments use imagery from camera sensors to determine the locations of the objects. Thus, example methods (e.g., algorithms) and example systems (e.g., special-purpose machines) are configured to improve an object location detection and mapping process. In example embodiments, a networked system accesses a plurality of raw two-dimensional (2-D) images (also referred to as “image data”) and associated image metadata (e.g., camera pose information such as location, direction pointed in). The 2-D images and associated image metadata do not provide depth information. The networked system detects objects in the plurality of images and fuses these detections across the plurality of images to infer three-dimensional (3-D) locations, orientations, and object types of the objects appearing in the plurality of images. The resulting collection of objects along with the location, orientation, and object type can be used to form a map (or be positioned as a layer on existing maps).

As a result, one or more of the methodologies described herein facilitate solving the technical problem of determining object locations without using complicated (and more expensive) equipment or more computationally expensive processes. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

The methodologies provide additional advantages over conventional methods. For example, the methodologies facilitate unsupervised and semi-supervised training of the networked system, which significantly reduces the cost of human labeling efforts. Further still, the methodologies allow for better predictions and probabilistic assignments given sensor data or the raw images. Example algorithm(s) used by the networked system are robust to noisy measurements. This facilitates better geo-locating of signs on streets, better detection of street names/numbers and business names, better estimated time of arrival (ETA) prediction on trips (e.g., from a pickup or starting location to a destination), better routing for directions, and better navigation and route planning for autonomous vehicles.

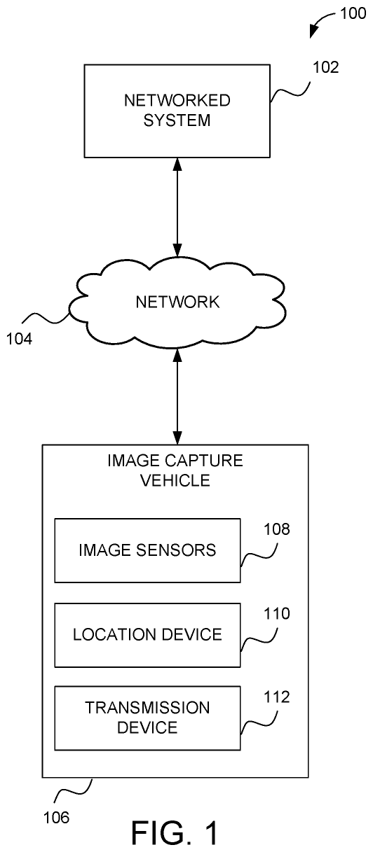

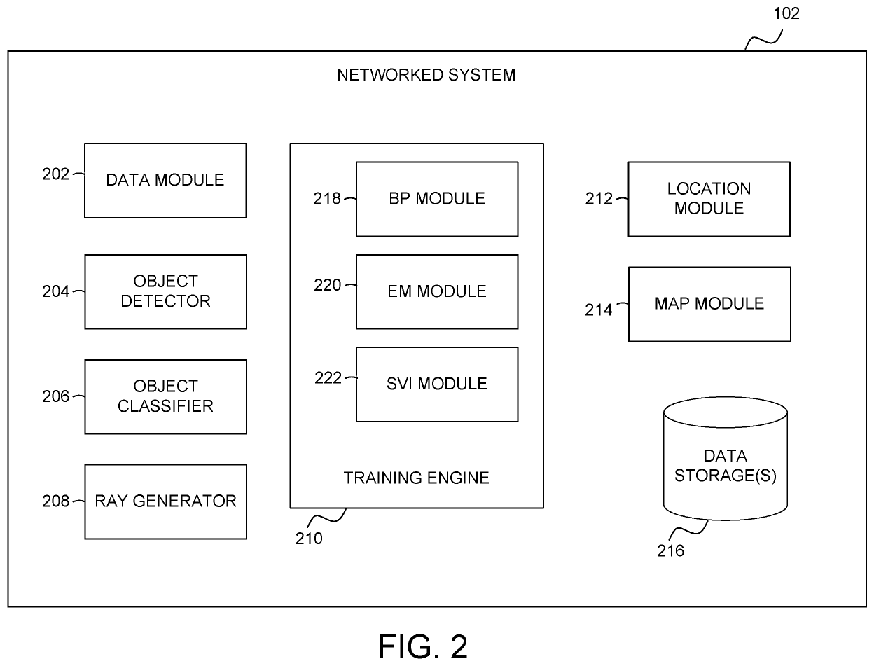

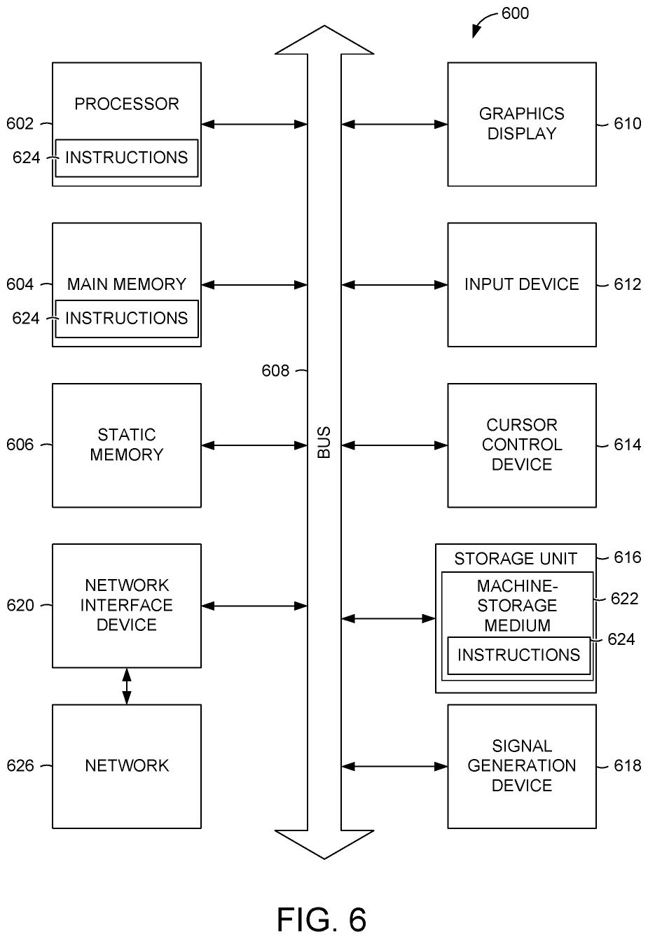

FIG. 1 is a diagram illustrating a network environment 100 suitable for performing object location detection using raw 2-D images, according to some example embodiments. The network environment 100 includes a networked system 102 communicatively coupled via a network 104 to an image capture vehicle 106. In example embodiments, the networked system 102 comprises components that accesses and analyses image data (e.g., images) captured by the image capture vehicle 106 in order to train the networked system 102 to accurately determine existence and location of objects in the real-world and to create maps displayable in a graphical user interface that indicate the existence and location of the objects. The objects comprise, for example, road signs (e.g., stop signs, yield signs, no parking signs), stop lights, street signs, addresses, any other signage that provides information, or objects that are desired to be mapped. The components of the networked system 102 are described in more detail in connection with FIG. 2 and may be implemented in a computer system, as described below with respect to FIG. 6.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the image capture vehicle 106 comprises a mobile transport that navigates along streets, roads, or other thoroughfares. The image capture vehicle 106 captures image data as it travels along the thoroughfares. As such, the image capture vehicle 106 comprises one or more image sensors 108 (e.g., cameras), a location device 110, and a transmission device 112. The image capture vehicle 106 includes other components that are not necessarily pertinent to example embodiments.

The image sensors 108 capture images (e.g., image data) that includes any objects that are along the thoroughfare such as, for example, buildings, trees, other vehicles, and signs. The image sensors 108 also records (or is associated with a device that records) a direction and/or angle that the image is captured relative to the image sensor 108. Thus, while the image data indicates a direction for each object, the image data does not indicate a distance or depth to each object.

The location device 110 detects a location of the image capture vehicle 106 when each image is captured by the image sensors 108. In example embodiments, the location device 110 comprises a global positioning system (GPS). In some embodiments, the location device 110 associates a location (e.g., latitude and longitude of the image capture vehicle) with each image.

The transmission device 112 manages the transmission of the captured data including the image data and corresponding metadata (e.g., the detected location of the image sensors 108 or image capture vehicle when each image is captured; direction camera is pointed in) to the networked system 102. In some embodiments, the transmission device 112 comprises one or more processors, memory, touch screen displays, wireless networking system (e.g., IEEE 802.11), and cellular telephony support (e.g., LTE/GSM/UMTS/CDMA/HSDP A). The transmission device 112 may interact with the networked system 102 through a client application (not shown). The client application allows for exchange of information with the networked system 102 via, for example, user interfaces.

In example embodiments, any of the systems, machines, sensors, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of image capture vehicles 106 may be embodied within the network environment 100. Furthermore, some components or functions of the network environment 100 may be combined or located elsewhere in the network environment 100. For example, some of the functions of the networked system 102 may be embodied within other systems or devices of the network environment 100.

While only a single networked system 102 is shown, alternative embodiments may contemplate having more than one networked systems 102 to perform operations discussed herein for the networked system 102. For example, one or more networked system 102 may be associated with each of a plurality of different areas in the world to train on the local images and image metadata. Having networked systems 102 that are focused on specific parts of the world is desirable since each area/region in the world may have different objects and signs and different parameters in detecting object locations.

FIG. 2 is a block diagram illustrating components of the networked system 102, according to some example embodiments. In various embodiments, the networked system 102 comprises a neural network that accesses and analyses images and associated image metadata captured by the image capture vehicle 106 in order to train the networked system 102 to accurately determine existence and location of objects in the real world, to perform the determination of the existence and location of the objects, and to create maps displayable in a graphical user interface that indicate the existence and location of the objects. To enable these operations, the networked system 102 comprises a data module 202, an object detector 204, an object classifier 206, a ray generator 208, a training engine 210, a location module 212, a map module 214, and a data storage 216 all configured to communicate with each other (e.g., via a bus, shared memory, or a switch). The networked system 102 may also comprise other components (not shown) that are not pertinent to example embodiments. Furthermore, any one or more of the components (e.g., engines, modules, storage) described herein may be implemented using hardware (e.g., a processor of a machine) or a combination of hardware and software. Moreover, any two or more of these components may be combined into a single component, and the functions described herein for a single component may be subdivided among multiple components.

The data module 202 manages access and storage of data. In particular, the data module 202 accesses the image data along with the associated image metadata from storage (e.g., one or more of the data storage(s) 216) where the networked system 102 stores the image data and image metadata upon receipt from the transmission device 112. Further still, the data module 202 stores data from the analysis to a data storage (e.g., one or more of the data storage(s) 216). The data from the analysis may include parameters, detected objects, and their locations determined by the training engine 210 and location module 210, as discussed further below. It is noted that any number of data storages 216 may be embodied at (or associated with) the networked system 102.

The object detector 204 detects objects in the images. In example embodiments, the object detector 204 comprises an image detection/recognition algorithm that analyses each image and detects one or more objects in the image. For example, the image detection algorithm may use edge detection to detect the one or more objects.

The object classifier 206 classifies the objects detected by the object detector 204. In example embodiments, the object classifier 206 takes each object and compares the object to a set of known objects to identify an object type. For example, the object detector 204 detects a red, eight-sided object with the word “STOP” printed thereon. The object classifier 206 takes that object, runs it against its database of known objects, and identifies the object type for the object as a stop sign. Objects that do not match any known objects may be discarded from further analysis.

The ray generator 208 generates a ray in 3-D space for each set of a detected object and associate image metadata. Accordingly, each ray has a position and a direction (the object is seen in) based on an origin (e.g., camera location based on location data in the image metadata). In example embodiments, each ray is a small piece of data comprising a ray origin, direction, and object type (e.g., determined by the object classifier 206). The ray may comprise other information (e.g., a confidence score) that may be used to determine location of the object.

The training engine 210 and the location module 212 take a plurality of rays (e.g., in batch mode) for a particular area, and clusters the rays based on a probabilistic model and using a nested set of inference algorithms, embodied within the modules of the training engine 210, to estimate each object's location. An object location is an intersection of the rays based on triangulation. The probabilistic model may also incorporate known information based on trainable distributions of objects (e.g., where each type of street sign tends to appear relative to street intersections or how GPS error tends to behave relative to building height) in estimating each object's location. For example, typically, stop signs are located at a corner near an intersection and not in the middle of a street. Therefore, an estimate that a stop sign is in the middle of the street may be treated as an outlier that is discarded.

The training engine 210 comprises the modules that train the networked system 102 to derive the probabilistic model used to detect object location. Once trained, the same modules can be used to locate remaining objects accurately. Accordingly, the training engine 210 comprises a belief propagation (BP) module 218, an expectation maximization (EM) module 220, and a stochastic variational inference (SVI) module 222, each comprising a corresponding algorithm. Some of the algorithms are nested within a prior algorithm. In example embodiments, a BP algorithm (or a variation of the BP algorithm) is nested within an EM algorithm, which in turn, is nested within a SVI algorithm.

The BP algorithm (or a variation of the BP algorithm) of the BP module 218 uses loopy belief propagation to cheaply approximate (e.g., determine a probability for) an assignment between detections and possible objects. The BP module 218 takes a set of rays and a set of objects the set of rays may be associated with (e.g., four stop signs and four rays). Based on noise characteristics, confidence scores, and geometry of the rays (e.g., direction and angle a camera/sensor is pointed at), the BP module 218 determines which of the objects (e.g., the four stop signs) actually exists (e.g., only two of the four stop signs exist). Additionally, the BP module 218 identifies which of the existing objects (e.g., two stop signs) each ray is likely associated with. The BP module 218 determines a probability for each ray (e.g., how likely does this ray correspond to this object). For example, when a bunch of rays approximately converges, a bunch of probabilities are determined. In actuality, there may be ten thousand rays and one thousand signs for a region/area. By using the BP algorithm (or a variation of the BP algorithm), the networked system 102 provides a modern method to solve this problem. In example embodiments, the BP algorithm may be represented by

$$P ( e , a ) ∝ γ ( e , a ) {\prod }_{i} {ψ}_{i}^{{e}_{i}} {\prod }_{ij} {ψ}_{ij}^{{a}_{ij}}$$

The next two example equations define the “messages” being propagated by the algorithm:

$$μ {}_{ij} = \frac{1}{1 + {( {ψ}_{i} {\prod }_{k \neq j} {v}_{kj} )}^{- 1}} \\ {v}_{ij} = 1 + \frac{{ψ}_{ij}}{1 + {\sum }_{l \neq i} {ψ}_{lj} μ {}_{lj}}$$

The next two example equations derive a final result of the first equation:

$${e}_{i} = \frac{1}{1 + {( {ψ}_{i} {\prod }_{j} {v}_{ij} )}^{- 1}}$$

$${a}_{ij} = \frac{{ψ}_{ij} {μ}_{ij}}{1 + {\sum }_{k} {ψ}_{kj} {μ}_{kj}}$$

In each BP iteration, messages are passed between detections and rays, and the marginal probabilities are computed for each edge according to the equations above. The output are existence and assignment probabilities (e_i, a_ij) in the equations above.

The EM module 220 iteratively predicts object locations given particular parameter settings (e.g., sign density, GPS error, observable radius, angle error, sign-to-intersection affinity) and the probabilities determined by the BP module 218. For each object, there is a probability for each ray associated with the object. The EM module 220 uses the probabilities to perform a probabilistic triangulation, whereby outliers are rejected. The rays that are probably associated with the same object are combined into a function that is minimized to find a probable location of the object. In example embodiments, the EM module 220 employs a differentiable trust-region Newton solver to estimate the location. In some embodiments, the EM module 220 performs a maximum likelihood with a PyTouch loss.

For example, the EM algorithm comprises the following component

xₙ₊₁=xₙ−[H+λI]⁻¹∇f(xₙ),n>0.

x is a large batch of object locations to be updated. f is a loss function, whereby f(x) is the same as loss. H is the Hessian matrix, which is a derivative matrix of a gradient of f (e.g., a derivative of f). A combination of the BP equation (i.e., the BP algorithm above) and the component forms the entire EM algorithm. The EM module 220 iteratively updates to solve for an optimal object location given the object location's association to the different rays and ray geometries (e.g., orientation, angle, or direction). In addition to geometry, the EM module 220 can incorporate prior known information into the function for optimization. The prior known information can include, for example, object sizes, object heights, prior GPS errors, camera orientation errors, predicted sign locations (e.g., stop signs on corners), predicted vehicle locations (e.g., not in a lake), and images with no objects (e.g., evidence of absence of objects).

The SVI module 222 manages parameter training. In example embodiments, the SVI algorithm of the SVI module 222 tunes the parameters (e.g., parameter settings). For example, the SVI module 222 can tune parameters associated with how much angle error is in each observation (e.g., image) or whether the confidence scores are accurate. The confidence scores are the probabilities that the detections are correct (e.g., the probability that the detection is a stop sign and not a red shirt).

In example embodiments, the location module 212 verifies whether the estimated/predicted locations are accurate (e.g., within a threshold amount of accuracy). The output of the training engine 210 are the estimated locations of the objects. The location module 212 compares the predicted locations to known locations of objects (e.g., from prior known information and existing map information). There may be false positives where objects are predicted where there are none, as well as false negatives where objects are missed where there should be objects.

In response to the detected false positives and false negatives, the SVI module 222 tunes the parameters to minimize the amount of false positives and false negatives in some combination. Thus, the training engine 210, and more particularly, the SVI module 222, can self-correct itself, iteratively, until the best possible results are obtained. It is iterative in that the SVI module 222 has initial guesses of top level parameters (e.g., sensors tend to have an angle error of 5 degrees), and the training engine 210 proceeds through the nested algorithm to obtain a better estimate. The first iteration through the nested algorithm will be off, but the parameters are tuned a bit to improve the accuracy of the networked system 102 (e.g., eventually learn that the actual angle accuracy is 3.35 degrees). In example embodiments, the SVI module 222 tunes all the parameters at the same time by maximizing the Evidence Lower Bound (ELBO) until a best solution is found. ELBO may be represented by the following equation: ELBO≡ [symbol] _{qϕ(z)} log p_{θ}(x, z)−log q_{ϕ}(z). As a result, each successive iteration will be less wrong (e.g., less false positives and false negatives). Any number of iterations may be performed.

Thus, the nested algorithms are iterative. In example embodiments, the training engine 210 uses space carving to find an initial object location to start with. The training engine 210 then uses a location sensitive hashing (LSH) algorithm to efficiently merge nearby clusters once their positions have been updated. For example, if there are two signs and after an update to their position the objects are almost right next to each other, then the training engine 210 combines those two potential signs into a single sign.

The data association algorithm (e.g., BP algorithm) and the optimization algorithm (e.g., EM module) are differentiable and implemented in a differentiable programming framework. This allows the networked system 102 to optimize the parameters (or top level parameters). In conventional methods, many of the parameters (e.g., hundreds) had to be hand tuned. Using example embodiments, the networked system 102 can automatically (e.g., using unsupervised or semi-supervised training) learn many of the parameters using the SVI algorithm.

The map module 214 uses the predicted locations to generate a map that includes the objects at their predicted locations. In some embodiments, the predicted locations may be used to generate a new map layer (or update an existing map layer) that is added to an existing map.

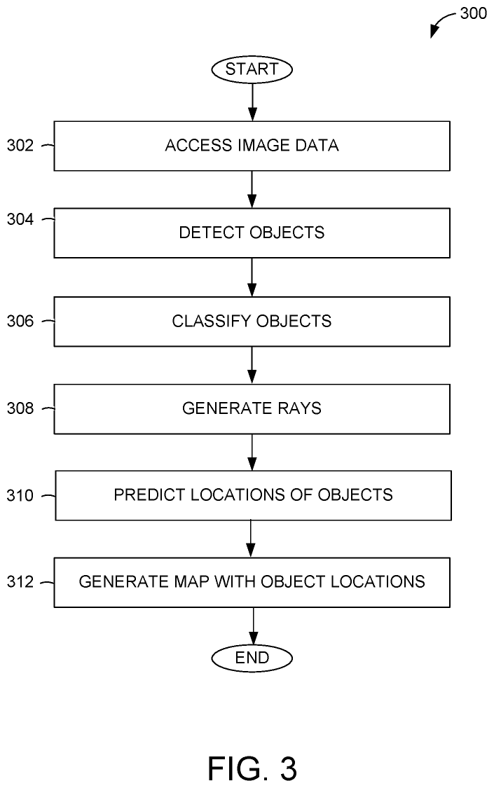

FIG. 3 is a flowchart illustrating operations of a method 300 for generating a map based on object locations predicted by the networked system 102, according to some example embodiments. Operations in the method 300 may be performed by the networked system 102, using components described above with respect to FIG. 2. Accordingly, the method 300 is described by way of example with reference to the networked system 102. However, it shall be appreciated that at least some of the operations of the method 300 may be deployed on various other hardware configurations or be performed by similar components residing elsewhere in the network environment 100. Therefore, the method 300 is not intended to be limited to the networked system 102.

In operation 302, image data is accessed. In example embodiments, the data module 202 accesses the image data along with the associated image metadata from storage (e.g., the data storage 216) where the networked system 102 stored the image data and image metadata upon receipt from the transmission device 112. The metadata includes, for example, sensor information such as location of the sensor, direction pointed in, and angle or orientation.

In operation 304, objects in the image data are detected. In example embodiments, the object detector 204 detects objects in the images using an image detection/recognition algorithm that analyses each image and detects one or more objects in the image.

In operation 306, the detected objects are classified. In example embodiments, the object classifier 206 classifies the objects detected in operation 304. Accordingly, the object classifier 206 takes each object and compares the object to a set of known objects to identify an object type. For example, the object detector 204 detects a red, eight-sided object with the word “STOP” printed thereon. The object classifier 206 takes that object, runs it against its database of known objects, and identifies the object type for the object as a stop sign.

In operation 308, rays are generated by the ray generator 208. Specifically, the ray generator 208 generates a ray in 3-D space for each set of detected object and associate image metadata. Accordingly, each ray has a position and a direction (the object is seen in) based on an origin (e.g., sensor location based on location data in the image metadata). In example embodiments, each ray is a small piece of data comprising a ray origin, direction, and object type (e.g., obtained in operation 306).

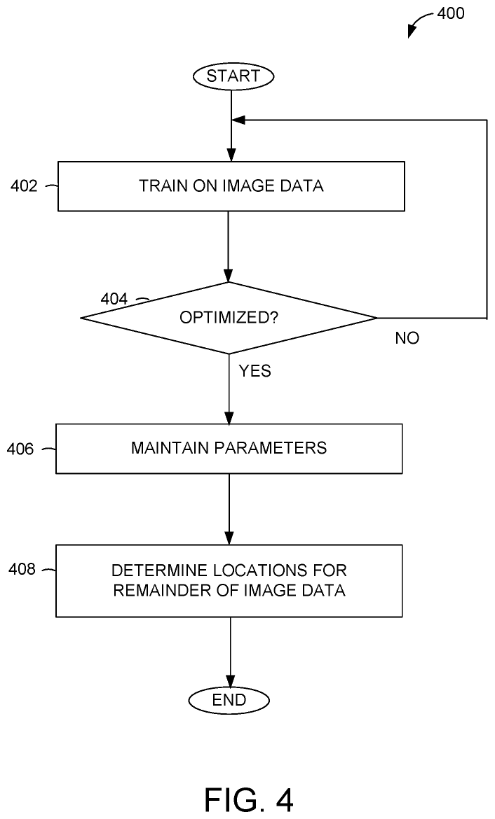

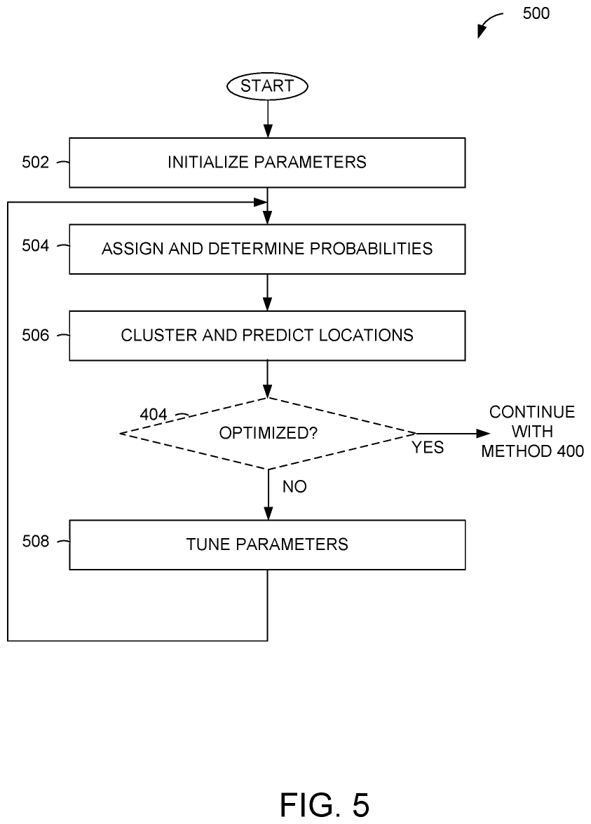

In operation 310, locations of the objects are predicted using the generated rays. The prediction of the locations is performed by the training engine 210 in connection with the location module 212. Operation 310 will be discussed in more detail in connection with FIG. 4 and FIG. 5 below.

In operation 312, a map (or map layer) is generated using the predicted object locations. In example embodiments, the map module 214 uses the predicted locations from operation 310 to generate a map that includes the objects at their predicted locations. In some embodiments, the predicted locations may be used to generate a new map layer (or update an existing map layer) that is added to an existing map.

FIG. 4 is a flowchart illustrating operations of a method 400 for determining map locations (e.g., operation 310) that includes machine training of parameters, according to some example embodiments. Operations in the method 400 may be performed by the networked system 102, using components described above with respect to FIG. 2. Accordingly, the method 400 is described by way of example with reference to the networked system 102. However, it shall be appreciated that at least some of the operations of the method 400 may be deployed on various other hardware configurations or be performed by similar components residing elsewhere in the network environment 100. Therefore, the method 400 is not intended to be limited to the networked system 102.

In operation 402, the training engine 210 trains on the image data. Operations 402 will be discussed in more detail in connection with FIG. 5 below.

In operation 404, the networked system 102 (e.g., the location module 212) determines whether location predictions are optimized. In example embodiments, optimization occurs when the loss converges (stops going down). As the networked system trains, the loss will start off huge and then get smaller and smaller with each training step. Eventually, the loss will stop getting smaller at which point location prediction is optimized. At this point, the networked system 102 analyzes the results and runs metrics on the predicted results (e.g., precision/recall metrics). In example embodiments, the location module 212 verifies whether the estimated/predicted locations obtained from the training are accurate (e.g., within a threshold amount of accuracy). For instance, the location module 212 compares the predicted locations to known locations of objects (e.g., from prior known information and existing map information). There may be false positives where objects are predicted where there are none, as well as false negatives where objects are missed where there should be objects.

If, in operation 404, the location module 212 determines that location prediction is not optimized, the method 400 returns to operation 402. However, if, in operation 404, the location module 212 determines that location prediction is optimized (e.g., that the networked system 102 is trained), the last set of parameters are maintained in operation 406. In operation 408, locations are determined for the remainder of image data (or new image data later obtained for the same region/area) using the maintained parameters.

FIG. 5 is a flowchart illustrating operations of a method 500 (e.g., operation 402) of machine training/learning on image data, according to some example embodiments. Operations in the method 500 may be performed by the networked system 102, using components described above with respect to FIG. 2. Accordingly, the method 500 is described by way of example with reference to the training engine 210. However, it shall be appreciated that at least some of the operations of the method 500 may be deployed on various other hardware configurations or be performed by similar components residing elsewhere in the network environment 100. Therefore, the method 500 is not intended to be limited to the training engine 210.

In operation 502, the parameters are initialized. In example embodiments, the SVI module 222 makes an initial guess of the parameters. In some cases, the initial guess may be a default set of parameters. These parameters are then used by the BP module 218 as discussed further below.

In operation 504, the BP module 218 assigns the rays to possible objects and determines the corresponding probabilities. In example embodiments, the BP algorithm (or a variation of the BP algorithm) of the BP module 218 uses loopy belief propagation to cheaply approximate an assignment between detections (e.g., the rays) and possible objects. The BP module 218 takes a set of rays and a set of objects the set of rays may be associated with. Based on noise characteristics, confidence scores, and geometry of the ray (e.g., direction and angle a camera/sensor is pointed at), the BP module 218 determines which of the objects exists. Additionally, the BP module 218 identifies which of the existing objects each ray is likely associated with. The BP module 218 determines the probability for each ray (e.g., how likely does this ray correspond to this object).

In operation 506, the EM module 220 clusters the rays and predicts locations based on the probabilities (e.g., based on a probabilistic model). In example embodiments, the EM module 220 uses the probabilities to perform a probabilistic triangulation, whereby outliers are rejected. The rays that are probably associated with the same object are combined into a function that is minimized to find a probable location of the object. In example embodiments, the EM module 220 employs a differentiable trust-region Newton solver to estimate the location. In some embodiments, the EM module 220 performs a maximum likelihood with a PyTouch loss.

After operation 506, the method 500 returns to operation 404. If location prediction is not optimized in operation 404, then training continues. Accordingly, in operation 508, the parameters are tuned by the SVI module 222 to minimize the amount of false positives and false negatives in some combination. Operations 504 and 506 are then repeated with the tuned parameters. The method 500 continues until location prediction is optimized.

FIG. 6 illustrates components of a machine 600, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIGS. 3-5. In one embodiment, the instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-storage media (e.g., tangible and non-transitory machine-storage media). The instructions 624 may be transmitted or received over a network 626 via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 622 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
accessing, by a networked system, image data and image metadata, the image data capturing images of a plurality of objects from different views, each image having corresponding image metadata;
detecting, by the networked system, each object in the plurality of objects in the image data;
generating, by at least one hardware processor of the networked system, a plurality of rays in three-dimensional space, each ray of the plurality of rays being generated based on the detected objects and the corresponding image metadata;
predicting, by the networked system, one or more object locations using the generated rays, the predicting being based on a probabilistic triangulation of the rays; and
updating, by the networked system, map data based on the predicted one or more object locations, the map data used to generate a map.

2. The method of claim 1, wherein the predicting comprises training the networked system to tune parameters used in predicting the one or more object locations.

3. The method of claim 2, wherein the training comprises:
setting each of the parameters to an initial value;
associating each ray with one of the detected objects;
determining a probability for each association of the ray and the detected object, the probability indicating how likely the ray corresponds to the detected object; and
using the probability to perform the probabilistic triangulation.

4. The method of claim 3, further comprising:
determining whether the parameters are optimized; and
either:
in response to the parameters not being optimized, repeating the associating, determining, and using; or
in response to the parameters being optimized, maintaining the parameters and using the parameters to predict locations of objects not included in the plurality of objects.

5. The method of claim 2, wherein the training comprises utilizing a belief propagation algorithm nested within an expectation maximization algorithm that is nested within a stochastic variational inference algorithm.

6. The method of claim 5, wherein the belief propagation algorithm determines a probability for each assignment between each ray and a known possible object.

7. The method of claim 6, wherein the expectation maximization algorithm clusters the plurality of rays and predicts locations based on the probability for each assignment.

8. The method of claim 5, further comprising:
verifying whether the predicted one or more object locations are within a threshold amount of accuracy, the verifying comprising comparing the predicted one or more object locations to known locations of objects from a database; and
in response to detected false positives and false negatives from the verifying, tuning the parameters to minimize an amount of false positives and false negatives.

9. The method of claim 1, further comprising classifying each of the plurality of objects, the classifying comprising comparing each of the plurality of objects to a database of known objects to identify an object type.

10. The method of claim 9, wherein each ray of the plurality of rays comprises a small piece of data that includes a ray origin, a ray direction, and the object type for a corresponding object.

11. The method of claim 1, wherein the predicting the one or more object locations further comprises incorporating known information based on trainable distributions of objects in predicting the one or more object locations.

12. A system comprising:
one or more hardware processors; and
a storage device storing instructions that, when executed by the one or more hardware processors, cause the one or more hardware processors to perform operations comprising:
accessing image data and image metadata, the image data capturing images of a plurality of objects from different views, each image having corresponding image metadata;
detecting each object in the plurality of objects in the image data;
generating a plurality of rays in three-dimensional space, each ray of the plurality of rays being generated based on the detected objects and the corresponding image metadata;
predicting one or more object locations using the generated rays, the predicting being based on a probabilistic triangulation of the rays; and
updating map data based on the predicted one or more object locations, the map data used to generate a map.

13. The system of claim 12, wherein the predicting comprises training a system to tune parameters used in predicting the one or more object locations.

14. The system of claim 13, wherein the training comprises:
setting each of the parameters to an initial value;
associating each ray with one of the detected objects;
determining a probability for each association of the ray and the detected object, the probability indicating how likely the ray corresponds to the detected object; and
using the probability to perform the probabilistic triangulation.

15. The system of claim 14, wherein the operations further comprise:
determining whether the parameters are optimized; and
either:
in response to the parameters not being optimized, repeating the associating, determining, and using; or
in response to the parameters being optimized, maintaining the parameters and using the parameters to predict locations of objects not included in the plurality of objects.

16. The system of claim 13, wherein the training comprises utilizing a belief propagation algorithm nested within an expectation maximization algorithm that is nested within a stochastic variational inference algorithm.

17. The system of claim 16, wherein the belief propagation algorithm determines a probability for each assignment between each ray and a known possible object.

18. The system of claim 17, wherein the expectation maximization algorithm clusters the plurality of rays and predicts locations based on the probability for each assignment.

19. The system of claim 16, wherein the operations further comprise:
verifying whether the predicted one or more object locations are within a threshold amount of accuracy, the verifying comprising comparing the predicted one or more object locations to known locations of objects from a database; and
in response to detected false positives and false negatives from the verifying, tuning the parameters to minimize an amount of false positives and false negatives.

20. A machine-storage medium storing instructions that, when executed by one or more hardware processors of a machine, cause the machine to perform operations comprising:
accessing image data and image metadata, the image data capturing images of a plurality of objects from different views, each image having corresponding image metadata;
detecting each object in the plurality of objects in the image data;
generating a plurality of rays in three-dimensional space, each ray of the plurality of rays being generated based on the detected objects and the corresponding image metadata;
predicting one or more object locations using the generated rays, the predicting being based on a probabilistic triangulation of the rays; and
updating map data based on the predicted one or more object locations, the map data used to generate a map.
